(19) United States
(12) Patent Application Publication
(10) Pub. No.: US 2025/0101625 A1
(43) Pub. Date: Mar. 27, 2025

(54) SURFACE TREATMENT METHOD OF COPPER FOIL, ANTIOXIDANT COPPER FOIL, AND CATHODE OF LITHIUM BATTERY

(71) Applicant: NAN YA PLASTICS CORPORATION, TAIPEI (TW)

(72) Inventors: TE-CHAO LIAO, TAIPEI (TW); WEI-SHENG CHENG, TAIPEI (TW); Yu-Chi Hsieh, TAIPEI (TW); Hsin-Hui Chiu, TAIPEI (TW)

(21) Appl. No.: 18/528,983

(22) Filed: Dec. 5, 2023

(30) Foreign Application Priority Data
Sep. 26, 2023 (TW) 112136707

(51) Int. Cl. C25D 3/10; C25D 3/08; C25D 7/06; H01M 4/02; H01M 4/62; H01M 4/66

(52) U.S. Cl. CPC C25D 3/10; C25D 3/08; C25D 7/0614; H01M 4/628; H01M 4/661; H01M 4/667; H01M 2004/021; H01M 2004/028

(57) ABSTRACT

A surface treatment method of a copper foil, an antioxidant copper foil, and a cathode of a lithium battery are provided. The antioxidant copper foil includes a copper foil substrate and an antioxidant layer formed thereon. The antioxidant layer contains chromium elements derived from a chromic acid compound, and contains nitrogen elements at least partially derived from an aminotetrazole compound and a nitrogen-containing heterocyclic compound. The antioxidant copper foil satisfies the following characteristics: (a) the antioxidant layer has a chromium content of between 5 and 35 μg/m² determined by XRF; (b) the antioxidant layer has a nitrogen content of between 0.1 and 10 wt % determined by XPS; (c) the antioxidant copper foil has a C—N signal detected by headspace GC-MS; and (d) after baking the antioxidant copper foil at 250° C. for 10 minutes, a surface color difference ΔE of the antioxidant layer is not greater than 8.

### CROSS-REFERENCE TO RELATED PATENT APPLICATION

This application claims the benefit of priority to Taiwan Patent Application No. 112136707, filed on Sep. 26, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a treatment method of a copper foil, and more particularly to a surface treatment method of a copper foil, an antioxidant copper foil, and a cathode of a lithium battery.

### BACKGROUND OF THE DISCLOSURE

In the related art, forming an antioxidant layer on a surface of a copper foil can protect the copper foil from oxidation. If the antioxidant layer is not formed on the surface of the copper foil, the surface of the copper foil is easily oxidized in room-temperature or high-temperature atmospheric conditions. As a result, the copper foil is unable to be stored for a long time, and is also unsuitable for a high-temperature operation. That is, the copper foil has poor heat resistance.

A conventional method for forming the antioxidant layer on the surface of the copper foil is achieved by electroplating, so as to form a nickel (Ni) plating layer, a zinc (Zn) plating layer, or a nickel-zinc (Ni—Zn) alloy plating layer.

However, the copper foil electroplated by the antioxidant layer that contains metal elements (e.g., nickel and zinc) is not suitable for use in lithium battery applications. If the copper foil is used in lithium batteries, performance and stability of the lithium battery may be reduced due to the metal elements (e.g., nickel and zinc).

In order to enable the copper foil to be applied to the lithium batteries, another type of the antioxidant layer (which contains chromic acid and glucose) is developed, such that the copper foil is prevented from being easily oxidized at a room temperature. Additionally, after heating the copper foil at an operating temperature of 180° C. for 10 minutes, a surface color difference ΔE of the copper foil can be less than 8, which indicates that the antioxidant layer has a certain degree of heat resistance.

However, at a higher temperature (e.g., 250° C.), the surface color difference ΔE of the copper foil covered by the antioxidant layer that contains the chromic acid and the glucose as components is still greater than 8, which restricts the applications of the copper foil.

### SUMMARY OF THE DISCLOSURE

In response to the above-referenced technical inadequacies, the present disclosure provides a surface treatment method of a copper foil and an antioxidant copper foil that can achieve a better degree of heat resistance as compared to a conventional copper foil. For instance, the copper foil provided by the present disclosure can still maintain a surface color difference ΔE of less than 8 when being baked at an operating temperature of 250° C. for 10 minutes.

In other words, the copper foil of the present disclosure demonstrates a more prominent degree of heat resistance as compared to the conventional copper foil (which uses chromic acid and glucose as components of the antioxidant layer).

In order to solve the above-mentioned problems, one of the technical aspects adopted by the present disclosure is to provide a surface treatment method of a copper foil, which includes: providing a copper foil substrate; immersing the copper foil substrate in an antioxidant solution containing a chromic acid compound, an aminotetrazole compound, and a nitrogen-containing heterocyclic compound; subjecting the copper foil substrate to be soaked or electroplated in the antioxidant solution for a predetermined time to form an antioxidant layer on a surface of the copper foil substrate, thereby forming an antioxidant copper foil. The antioxidant copper foil satisfies the following characteristics: (a) the antioxidant layer has a chromium content of between 5 μg/m² and 35 μg/m² determined by X-ray Fluorescence Spectroscopy (XRF), in which chromium elements in the antioxidant layer are derived from the chromic acid compound; (b) the antioxidant layer has a nitrogen content of between 0.1 wt % and 10 wt % determined by X-ray Photoelectron Spectroscopy (XPS), in which nitrogen elements in the antioxidant layer are at least partially derived from the aminotetrazole compound and the nitrogen-containing heterocyclic compound; (c) the antioxidant copper foil has a C—N signal detected by headspace gas chromatography/mass spectrometry; and (d) after baking the antioxidant copper foil at 250° C. for 10 minutes, a surface color difference ΔE of the antioxidant layer is not greater than 8 before and after baking.

In one of the possible or preferred embodiments, in the antioxidant solution, a concentration of the chromic acid compound is between 0.1 g/L and 5 g/L, and the chromic acid compound is selected from the group consisting of chromic acid, dichromic acid, and potassium dichromate.

In one of the possible or preferred embodiments, in the antioxidant solution, a concentration of the aminotetrazole compound is between 0.1 g/L and 10 g/L, a concentration of the nitrogen-containing heterocyclic compound is between 0.1 g/L and 10 g/L, and a weight ratio between the aminotetrazole compound and the nitrogen-containing heterocyclic compound is between 1:5 and 5:1.

In one of the possible or preferred embodiments, the aminotetrazole compound is 5-aminotetrazole, and the nitrogen-containing heterocyclic compound is a bicyclic nitrogen-containing heterocyclic compound.

In one of the possible or preferred embodiments, the nitrogen-containing heterocyclic compound is benzotriazole.

In one of the possible or preferred embodiments, the antioxidant solution further contains at least two of 1,5-diaminotetrazole, 2-amino-1,3,4-thiadiazole, and 3,5-diamino-1,2,4-triazole.

In one of the possible or preferred embodiments, the predetermined time for soaking or electroplating the copper foil substrate in the antioxidant solution is between 0.1 seconds and 10 seconds, and an electroplating condition for electroplating the copper foil substrate is a current density of between 0.1 and 5 ASD (A/dm²).

In order to solve the above-mentioned problems, another one of the technical aspects adopted by the present disclosure is to provide an antioxidant copper foil that includes a copper foil substrate and an antioxidant layer formed on a surface of the copper foil substrate. The antioxidant layer contains chromium elements derived from a chromic acid compound, and contains nitrogen elements at least partially derived from an aminotetrazole compound and a nitrogen-containing heterocyclic compound. The antioxidant copper foil satisfies the following characteristics.

(a) The antioxidant layer has a chromium content of between 5 μg/m² and 35 μg/m² determined by X-ray Fluorescence Spectroscopy (XRF).

(b) The antioxidant layer has a nitrogen content of between 0.1 wt % and 10 wt % determined by X-ray Photoelectron Spectroscopy (XPS).

(c) The antioxidant copper foil has a C—N signal detected by headspace gas chromatography/mass spectrometry.

(d) After baking the antioxidant copper foil at 250° C. for 10 minutes, a surface color difference ΔE of the antioxidant layer is not greater than 8 before and after baking.

In one of the possible or preferred embodiments, a thickness of the copper foil substrate is between 1 micrometer and 10 micrometers, and a thickness of the antioxidant layer is between 1 nanometer and 100 nanometers.

In order to solve the above-mentioned problems, yet another one of the technical aspects adopted by the present disclosure is to provide a cathode of a lithium battery that includes the antioxidant copper foil as mentioned above.

Therefore, in the surface treatment method of the copper foil, the antioxidant copper foil, and the cathode of the lithium battery provided by the present disclosure, by virtue of “an antioxidant copper foil including a copper foil substrate and an antioxidant layer formed on a surface of the copper foil substrate,” “the antioxidant layer containing chromium elements derived from a chromic acid compound, and containing nitrogen elements at least partially derived from an aminotetrazole compound and a nitrogen-containing heterocyclic compound,” and “the antioxidant copper foil satisfying the following characteristics: (a) the antioxidant layer has a chromium content of between 5 μg/m² and 35 μg/m² determined by X-ray fluorescence spectroscopy (XRF); (b) the antioxidant layer has a nitrogen content of between 0.1 wt % and 10 wt % determined by X-ray photoelectron spectroscopy (XPS); (c) the antioxidant copper foil has a C—N signal detected by headspace gas chromatography-mass spectrometry; and (d) after baking the antioxidant copper foil at 250° C. for 10 minutes, a surface color difference ΔE of the antioxidant layer is not greater than 8 before and after the baking,” the copper foil of the present disclosure demonstrates a more prominent degree of heat resistance as compared to the conventional copper foil (which uses chromic acid and glucose as components of an antioxidant layer).

Furthermore, the copper foil of the present disclosure is more suitable for use as a cathode material of the lithium battery, thereby enabling a product to have a wider range of applications.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a surface treatment method of a copper foil according to an embodiment of the present disclosure;

FIG. 2 is a schematic view of forming an antioxidant layer on a surface of the copper foil as shown in FIG. 1;

FIG. 3 is a schematic view showing the antioxidant layer being formed on one surface of the copper foil according to the embodiment of the present disclosure;

FIG. 4 is a schematic view showing the antioxidant layer being formed on each of two surfaces of the copper foil according to another embodiment of the present disclosure;

FIG. 5 is a schematic view of a variation of the surface treatment method of the copper foil according to yet another embodiment of the present disclosure; and

FIG. 6 is a schematic view of a variation of the surface treatment method of the copper foil according to still another embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### [Surface Treatment Method of Copper Foil]

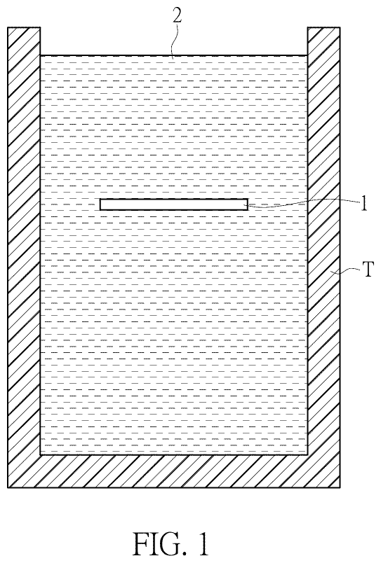

Referring to FIG. 1 to FIG. 6, an embodiment of the present disclosure provides a surface treatment method of a copper foil. The surface treatment method includes step S110, step S120, step S130, step S140, and step S150.

It should be noted that the sequence of steps and actual implementations described in the present embodiment can be adjusted according to actual needs, and are not limited to those described in the present embodiment.

Step S110 includes: providing a copper foil substrate 1.

The copper foil substrate 1 can be, for example, an electrolytic copper foil or a rolled copper foil. In one embodiment of the present disclosure, the copper foil substrate 1 is an electrolytic copper foil and is suitable for producing a cathode of a lithium battery, but the present disclosure is not limited thereto. Further, a thickness of the copper foil substrate 1 can be, for example, between 1 micrometer and 10 micrometers, and preferably between 3 micrometers and 8 micrometers. In the present embodiment, step S110 further includes: washing the copper foil substrate 1 with water to remove impurities or chemical residues on a surface of the copper foil substrate 1.

Step S120 includes: preparing an antioxidant solution 2 in a liquid storage tank T, and immersing the copper foil substrate 1 in the antioxidant solution 2 as shown in FIG. 1. The antioxidant solution 2 includes at least a chromic acid compound (1), an aminotetrazole compound (2), and a nitrogen-containing heterocyclic compound (3). Further, a concentration of the chromic acid compound in the antioxidant solution is preferably between 0.1 g/L and 5 g/L, and more preferably between 0.1 g/L and 2 g/L.

In some embodiments of the present disclosure, the chromic acid compound is selected from the group consisting of chromic acid, dichromic acid, and potassium dichromate.

The chromic acid compound is preferably chromic acid.

The chemical formula of chromic acid is H₂CrO₄, and its chemical structure is as follows:

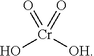

The chemical formula of dichromic acid is H₂Cr₂O₇, and its chemical structure is as follows:

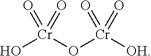

The chemical formula of potassium dichromate is K₂Cr₂O₇, and its chemical structure is as follows:

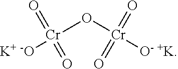

Furthermore, the aminotetrazole compound is 5-aminotetrazole that has the chemical formula of HN₄CNH₂, and its chemical structure is as follows:

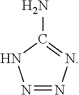

A concentration of the aminotetrazole compound in the antioxidant solution is preferably between 0.1 g/L and 10 g/L, and more preferably between 2 g/L and 8 g/L.

Furthermore, the nitrogen-containing heterocyclic compound is a bicyclic nitrogen-containing heterocyclic compound, and is preferably benzotriazole. The bicyclic nitrogen-containing heterocyclic compound can also be, for example, indoline or 1,4-diazabicyclo[2.2.2]octane, but the present disclosure is not limited thereto.

The chemical formula of benzotriazole is C₆H₅N₃, and its chemical structure is as follows:

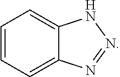

A concentration of the nitrogen-containing heterocyclic compound in the antioxidant solution is preferably between 0.1 g/L and 10 g/L, and more preferably between 2 g/L and 8 g/L.

A mass ratio between the aminotetrazole compound and the nitrogen-containing heterocyclic compound ranges from 1:5 to 5:1, and preferably ranges from 1:2 to 2:1, but the present disclosure is not limited thereto.

The antioxidant solution 2 can further include at least one of the following aminotriazole compounds (4) to (6): 1,5-diaminotetrazole (4); 2-amino-1,3,4-thiadiazole (5); and 3,5-diamino-1,2,4-triazole (6).

The chemical formula of 1,5-diaminotetrazole is CH₄N₆, and its chemical structure is as follows:

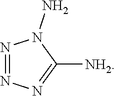

The chemical formula of 2-amino-1,3,4-thiadiazole is C₂H₃N₃S, and its chemical structure is as follows:

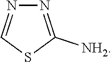

The chemical formula of 3,5-diamino-1,2,4-triazole is C₂H₅N₅, and its chemical structure is as follows:

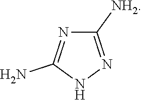

In some embodiments of the present disclosure, the antioxidant solution 2 contains at least two of the following compounds: 1,5-diaminotetrazole, 2-amino-1,3,4-thiadiazole, and 3,5-diamino-1,2,4-triazole.

Furthermore, in the antioxidant solution, a total concentration of the aminotriazole compounds (4) to (6) is between 0.1 g/L and 100 g/L, and preferably between 1 g/L and 20 g/L.

In the antioxidant solution 2, a concentration of 1,5-diaminotetrazole is between 1 g/L and 100 g/L (preferably between 1 g/L and 10 g/L), a concentration of 2-amino-1,3,4-thiadiazole is between 0.1 g/L and 10 g/L, and a concentration of 3,5-diamino-1,2,4-triazole is between 0.1 and 10 g/L. However, the present disclosure is not limited thereto.

In the present embodiment, a liquid component of the antioxidant solution 2 is water, such as deionized water (DI), reverse osmosis water (RO), or ultrapure water (MQ), but the present disclosure is not limited thereto.

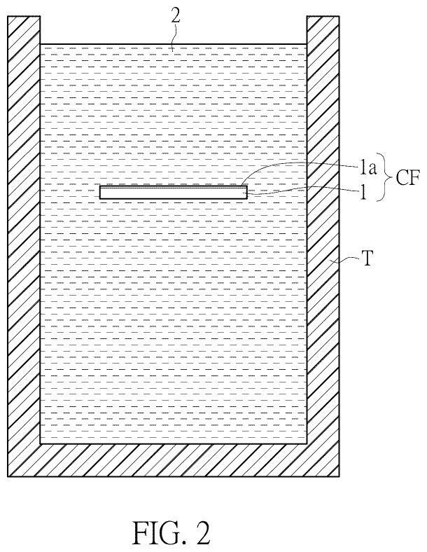

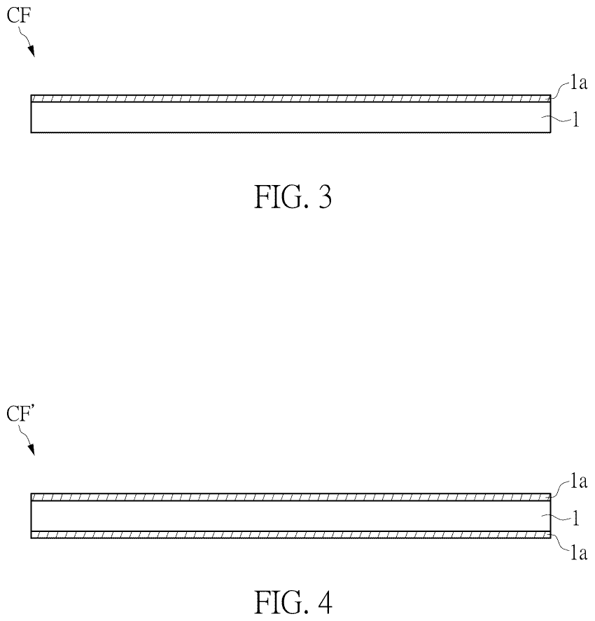

Step S130 includes: subjecting the copper foil substrate 1 to be soaked or electroplated in the antioxidant solution 2, such that an antioxidant layer 1a is formed on a surface of the copper foil substrate 1 as shown in FIG. 2 and FIG. 3. A thickness of the antioxidant layer 1a is between 1 nanometer and 100 nanometers, and preferably between 1 nanometer and 30 nanometers.

A shown in FIG. 4, in another embodiment of the present disclosure, the antioxidant layer 1a is formed on each of two surfaces of the copper foil substrate 1.

Furthermore, the copper foil substrate 1 is soaked or electroplated in the antioxidant solution 2 for a predetermined time, so as to form the antioxidant layer 1a.

In some embodiments of the present disclosure, the predetermined time is between 0.1 seconds and 10 seconds, and preferably between 0.5 seconds and 5 seconds.

For example, the predetermined time can be 0.3 seconds, 0.5 seconds, 1 second, 3 seconds, or 5 seconds.

Moreover, an electroplating condition for electroplating the copper foil substrate 1 in the antioxidant solution 2 is a current density of between 0.1 ASD (i.e., A/dm²) and 5 ASD.

For example, the current density can be 0.5 ASD, 0.8 ASD, or 1 ASD.

It is worth mentioning that in the present embodiment, the copper foil substrate 1 is an individual sheet that is immersed in the antioxidant solution 2, but the present disclosure is not limited thereto.

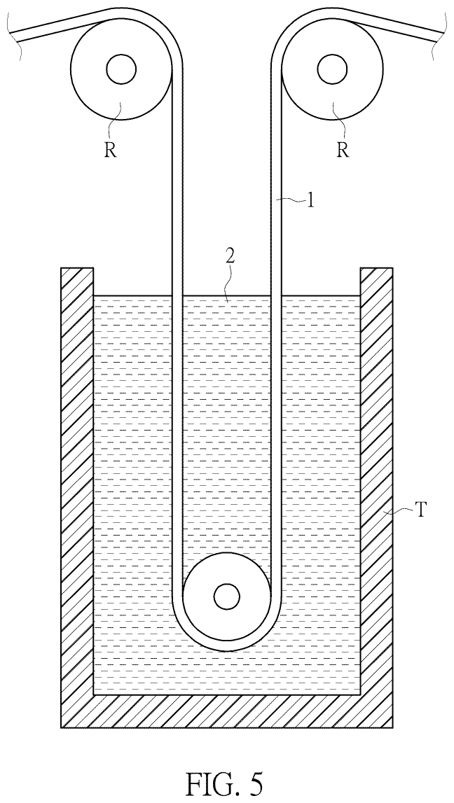

Referring to FIG. 5, in one embodiment of the present disclosure, the copper foil substrate 1 is a sheet in a continuous and rollable form. The copper foil substrate 1 can be guided into the antioxidant solution 2 via multiple guide rollers R that are disposed inside and around the liquid storage tank T.

Furthermore, the predetermined time for soaking or electroplating the copper foil substrate 1 in the antioxidant solution 2 can be adjusted by controlling the rolling speed of the multiple guide rollers R.

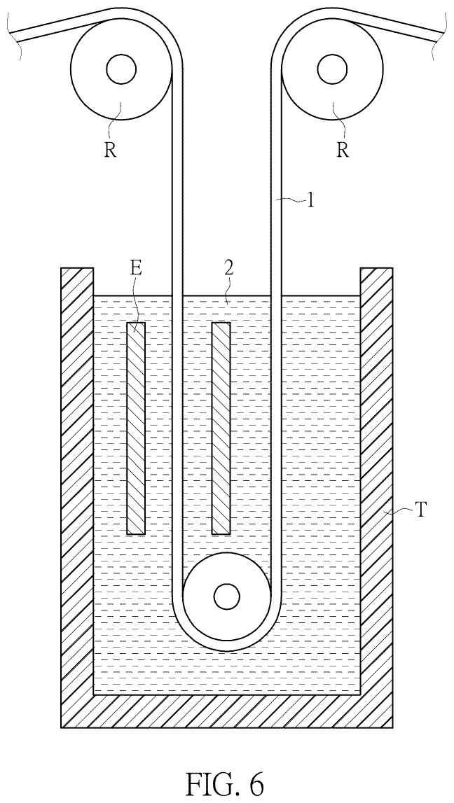

Referring to FIG. 6, in another embodiment of the present disclosure, at least one pair of electrodes E are further disposed inside the liquid storage tank T, so that the copper foil substrate 1 immersed in the antioxidant solution 2 can undergo an electroplating process through the energization of the electrodes E. However, the present disclosure is not limited thereto.

Step S140 includes: taking out the copper foil substrate 1 having the antioxidant layer 1a from the antioxidant solution 2; and blowing and drying the copper foil substrate 1 to remove excess liquid components (e.g., moisture) from the antioxidant layer 1a.

Step S150 includes: rolling up the copper foil substrate 1 having the antioxidant layer 1a to complete the preparation of an antioxidant copper foil CF, but the present disclosure is not limited thereto.

### [Antioxidant Copper Foil]

As shown in FIG. 3, an embodiment of the present disclosure provides an antioxidant copper foil CF that includes a copper foil substrate 1 and an antioxidant layer 1a formed on a surface of the copper foil substrate 1.

A shown in FIG. 4, in another embodiment of the present disclosure, the antioxidant layer 1a is formed on each of two surfaces of the copper foil substrate 1.

A thickness of the copper foil substrate 1 is between 1 micrometer and 10 micrometers, and preferably between 5 micrometers and 8 micrometers.

A thickness of the antioxidant layer 1a is between 1 nanometer and 100 nanometers, and preferably between 1 nanometer and 30 nanometers, but the present disclosure is not limited thereto.

The antioxidant copper foil CF is suitable for the production of a cathode of a lithium battery, and the antioxidant copper foil CF satisfies the following characteristics (a) to (d).

(a) The antioxidant layer 1a of the antioxidant copper foil CF has a chromium content of between 5 μg/m² and 35 μg/m² (preferably between 10 μg/m² and 30 μg/m²) determined by X-ray Fluorescence Spectroscopy (XRF). Chromium elements in the antioxidant layer 1a are derived from the chromic compound present in the antioxidant solution 2, such as chromic acid, dichromic acid, and/or potassium dichromate. It is worth mentioning that X-ray Fluorescence Spectroscopy (XRF) employs high-energy X-rays or gamma rays to excite secondary X-rays from the material, is used for elemental and chemical analysis, and can quantify the chromium content in the material.

(b) The antioxidant layer 1a of the antioxidant copper foil CF has a nitrogen content of between 0.1 wt % and 10 wt % (preferably between 0.1 wt % and 5 wt %, and more preferably between 0.1 wt % and 2 wt %) determined by X-ray Photoelectron Spectroscopy (XPS). Nitrogen elements in the antioxidant layer 1a are at least partially derived from the aminotetrazole compound and the nitrogen-containing heterocyclic compound present in the antioxidant solution 2. Further, another part of the nitrogen elements is derived from at least one of 1,5-diaminotetrazole, 2-amino-1,3,4-thiadiazole, and 3,5-diamino-1,2,4-triazole. It is worth mentioning that X-ray Photoelectron Spectroscopy (XPS) is a quantitative spectroscopic technique that is used to determine an elemental composition, an empirical formula, and chemical states and electronic states of the elements within a material. This technique involves irradiating the material to be analyzed with X-rays while measuring the kinetic energy and the number of electrons that escape from an underside (within a range of from 1 nm to 10 nm) of a surface of the material, thereby obtaining an X-ray photoelectron spectrum.

(c) The antioxidant copper foil CF has a C—N signal (carbon-nitrogen signal) detected by headspace gas chromatography/mass spectrometry (headspace GC-MS). The detecting method of headspace gas chromatography/mass spectrometry includes heating the antioxidant copper foil CF to a temperature of between 150° C. and 250° C. The gases produced by a sample are introduced into the headspace gas chromatography/mass spectrometry for analysis, which outputs results of a mass spectrum. The results can then be evaluated to determine if there is a peak corresponding to the carbon-nitrogen signal.

(d) After baking the antioxidant copper foil CF in an oven at 250° C. for 10 minutes, a surface color difference ΔE of the antioxidant layer 1a of the antioxidant copper foil CF observed by a chroma meter is not greater than 8 before and after baking.

According to the above configuration, the antioxidant copper foil CF of the present disclosure is not easily oxidized at a room temperature or a high temperature, and has better heat resistance as compared to a conventional copper foil that uses chromic acid and glucose as antioxidant components.

It is worth mentioning that in the antioxidant solution 2 used for forming the antioxidant layer 1a, the nitrogen-containing heterocyclic compound (e.g., benzotriazole) is used for forming a main body of the antioxidant layer 1a, which enables the antioxidant layer 1a to have basic antioxidant properties and thermal stability. The aminotetrazole compound (e.g., 5-amino-tetrazole) is used to enhance a density of the antioxidant layer 1a, thus effectively improving the aforementioned antioxidant properties and thermal stability. Other amino-containing tetrazole compounds in the antioxidant solution 2 can form a complex mixture to reinforce the antioxidant properties.

### Experimental Data and Test Results

Hereinafter, a more detailed description will be provided with reference to Exemplary Examples 1 to 4 and Comparative Examples 1 and 2. These examples are intended solely for the purpose of illustration and should not be construed as limiting the scope of the present disclosure.

Exemplary Example 1: An antioxidant solution is prepared. The antioxidant solution is an aqueous solution containing 0.6 g/L of chromic acid, 5 g/L of 5-amino-tetrazole, 5 g/L of benzotriazole, 2 g/L of 1,5-diaminotetrazole, 5 g/L of 2-amino-1,3,4-thiadiazole, and 2 g/L of 3,5-diamino-1,2,4-triazole. A copper foil substrate (i.e., an electrolytic copper foil having a thickness of about 6 micrometers) is washed with water, and the copper foil substrate is then immersed in the antioxidant solution. The copper foil substrate is subjected to an electroplating process for 0.5 seconds under a condition of a current density being 0.8 ASD, such that an antioxidant layer is formed on a surface of the copper foil substrate, and an antioxidant copper foil is further obtained. Subsequently, the antioxidant copper foil is taken out from the antioxidant solution, air-dried, and wound up to complete the preparation of the antioxidant copper foil.

In the test results, the antioxidant copper foil of Exemplary Example 1 has a chromium content of 20 μg/m² analyzed by XRF, a nitrogen content of 0.5 wt % analyzed by XPS, and a C—N signal detected by headspace GC/MS. Additionally, after baking the antioxidant copper foil at 250° C. for 10 minutes, a surface color difference ΔE of the antioxidant layer is not greater than 8 before and after baking. The antioxidant copper foil in Exemplary Example 1 demonstrates superior antioxidant properties and thermal resistance.

Exemplary Example 2: An antioxidant solution is prepared. The antioxidant solution is an aqueous solution containing 0.6 g/L of chromic acid, 5 g/L of 5-amino-tetrazole, 5 g/L of benzotriazole, 2 g/L of 2-amino-1,3,4-thiadiazole, and 5 g/L of 3,5-diamino-1,2,4-triazole. A copper foil substrate (i.e., an electrolytic copper foil having a thickness of about 6 micrometers) is washed with water, and the copper foil substrate is then immersed in the antioxidant solution. The copper foil substrate is subjected to an electroplating process for 0.5 seconds under a condition of a current density being 0.8 ASD, such that an antioxidant layer is formed on a surface of the copper foil substrate, and an antioxidant copper foil is further obtained. Subsequently, the antioxidant copper foil is taken out from the antioxidant solution, air-dried, and wound up to complete the preparation of the antioxidant copper foil.

In the test results, the antioxidant copper foil of Exemplary Example 2 has a chromium content of 20 μg/m² analyzed by XRF, a nitrogen content of 0.5 wt % analyzed by XPS, and a C—N signal detected by headspace GC/MS. Additionally, after baking the antioxidant copper foil at 250° C. for 10 minutes, a surface color difference ΔE of the antioxidant layer is not greater than 8 before and after baking. The antioxidant copper foil in Exemplary Example 2 demonstrates superior antioxidant properties and thermal resistance.

Exemplary Example 3: An antioxidant solution is prepared. The antioxidant solution is an aqueous solution containing 0.6 g/L of chromic acid, 5 g/L of 5-amino-tetrazole, 5 g/L of 1,5-diaminotetrazole, 2 g/L of 2-amino-1,3,4-thiadiazole, and 2 g/L of 3,5-diamino-1,2,4-triazole. The antioxidant solution does not contain benzotriazole. A copper foil substrate (i.e., an electrolytic copper foil having a thickness of about 6 micrometers) is washed with water, and the copper foil substrate is then immersed in the antioxidant solution. The copper foil substrate is subjected to an electroplating process for 0.5 seconds under a condition of a current density being 0.8 ASD, such that an antioxidant layer is formed on a surface of the copper foil substrate, and an antioxidant copper foil is further obtained. Subsequently, the antioxidant copper foil is taken out from the antioxidant solution, air-dried, and wound up to complete the preparation of the antioxidant copper foil.

In the test results, the antioxidant copper foil of Exemplary Example 3 has a chromium content of 20 μg/m² analyzed by XRF, a nitrogen content of 0.5 wt % analyzed by XPS, and a C—N signal detected by headspace GC/MS. Additionally, after baking the antioxidant copper foil at 250° C. for 10 minutes, a surface color difference ΔE of the antioxidant layer is greater than 10 before and after baking.

The antioxidant properties and thermal resistance of the antioxidant copper foil of Exemplary Example 3 are slightly inferior to those of Exemplary Examples 1 and 2, which could be attributed to a lower density of the antioxidant layer of Exemplary Example 3 as compared to those of Exemplary Examples 1 and 2.

Exemplary Example 4: An antioxidant solution is prepared. The antioxidant solution is an aqueous solution containing 0.6 g/L of chromic acid, 5 g/L of benzotriazole, 2 g/L of 1,5-diaminotetrazole, 5 g/L of 2-amino-1,3,4-thiadiazole, and 2 g/L of 3,5-diamino-1,2,4-triazole. The antioxidant solution does not contain 5-amino-tetrazole. A copper foil substrate (i.e., an electrolytic copper foil having a thickness of about 6 micrometers) is washed with water, and the copper foil substrate is then immersed in the antioxidant solution. The copper foil substrate is subjected to an electroplating process for 0.5 seconds under a condition of a current density being 0.8 ASD, such that an antioxidant layer is formed on a surface of the copper foil substrate, and an antioxidant copper foil is further obtained. Subsequently, the antioxidant copper foil is taken out from the antioxidant solution, air-dried, and wound up to complete the preparation of the antioxidant copper foil.

In the test results, the antioxidant copper foil of Exemplary Example 4 has a chromium content of 20 μg/m² analyzed by XRF, a nitrogen content of 0.5 wt % analyzed by XPS, and a C—N signal detected by headspace GC/MS. Additionally, after baking the antioxidant copper foil at 250° C. for 10 minutes, a surface color difference ΔE of the antioxidant layer is greater than 10 before and after baking. The antioxidant properties and thermal resistance of the antioxidant copper foil of Exemplary Example 4 are slightly inferior to those of Exemplary Examples 1 and 2, which could be attributed to a lower density of the antioxidant layer of Exemplary Example 4 as compared to those of Exemplary Examples 1 and 2.

Comparative Example 1: An antioxidant solution is prepared. The antioxidant solution is an aqueous solution containing 0.6 g/L of chromic acid and 2 g/L of 3,5-diamino-1,2,4-triazole. The antioxidant solution does not contain 5-amino-tetrazole and benzotriazole. A copper foil substrate (i.e., an electrolytic copper foil having a thickness of about 6 micrometers) is washed with water, and the copper foil substrate is then immersed in the antioxidant solution. The copper foil substrate is subjected to an electroplating process for 0.5 seconds under a condition of a current density being 0.8 ASD, such that an antioxidant layer is formed on a surface of the copper foil substrate, and an antioxidant copper foil is further obtained. Subsequently, the antioxidant copper foil is taken out from the antioxidant solution, air-dried, and wound up to complete the preparation of the antioxidant copper foil.

In the test results, while the antioxidant copper foil of Comparative Example 1 has a chromium content of 20 μg/m² analyzed by XRF, and a nitrogen content of 0 wt % analyzed by XPS (no nitrogen content), there is no C—N signal to be detected by headspace GC/MS. Additionally, after baking the antioxidant copper foil at 250° C. for 10 minutes, a surface color difference ΔE of the antioxidant layer is greater than 20 before and after baking. The antioxidant properties and thermal resistance of the antioxidant copper foil of Comparative Example 1 are significantly inferior to those of Exemplary Examples 1 and 2.

Comparative Example 2: An antioxidant solution is prepared. The antioxidant solution is an aqueous solution containing 0.6 g/L of chromic acid and 2 g/L of 2-amino-1,3,4-thiadiazole. The antioxidant solution does not contain 5-amino-tetrazole and benzotriazole. A copper foil substrate (i.e., an electrolytic copper foil having a thickness of about 6 micrometers) is washed with water, and the copper foil substrate is then immersed in the antioxidant solution. The copper foil substrate is subjected to an electroplating process for 0.5 seconds under a condition of a current density being 0.8 ASD, such that an antioxidant layer is formed on a surface of the copper foil substrate, and an antioxidant copper foil is further obtained. Subsequently, the antioxidant copper foil is taken out from the antioxidant solution, air-dried, and wound up to complete the preparation of the antioxidant copper foil.

In the test results, while the antioxidant copper foil of Comparative Example 2 has a chromium content of 20 μg/m² analyzed by XRF, and a nitrogen content of 0 wt % analyzed by XPS (no nitrogen content), there is no C—N signal to be detected by headspace GC/MS. Additionally, after baking the antioxidant copper foil at 250° C. for 10 minutes, a surface color difference ΔE of the antioxidant layer is greater than 20 before and after baking. The antioxidant properties and thermal resistance of the antioxidant copper foil of Comparative Example 2 are significantly inferior to those of Exemplary Examples 1 and 2.

Analysis methods of the chromium content (by XRF), the nitrogen content (by XPS), the qualitative C—N signal (by headspace GC/MS), and the surface color difference ΔE have been described above, and will not be reiterated herein.

TABLE 1

| | | Exemplary | Exemplary | Exemplary | Exemplary |
|---|---|---|---|---|---|
| | Items | Example 1 | Example 2 | Example 3 | Example 4 |
| antioxidant | Content of | 0.6 | 0.6 | 0.6 | 0.6 |
| solution | chromic acid | | | | |
| | (g/L) | | | | |
| | Content of 5- | 5 | 5 | 5 | 0 |
| | amino-tetrazole | | | | |
| | (g/L) | | | | |
| | Content of | 5 | 5 | 0 | 5 |
| | benzotriazole | | | | |
| | (g/L) | | | | |
| | Content of 1,5- | 2 | 0 | 5 | 2 |
| | diaminotetrazole | | | | |
| | (g/L) | | | | |
| | Content of 2- | 5 | 2 | 2 | 5 |
| | amino-1,3,4- | | | | |
| | thiadiazole | | | | |
| | (g/L) | | | | |
| | Content of 3,5- | 2 | 5 | 2 | 2 |
| | diamino-1,2,4- | | | | |
| | triazole (g/L) | | | | |
| Processing | Immersion | 25° C. | 25° C. | 25° C. | 25° C. |
| conditions | temperature | | | | |
| | (° C.) | | | | |
| | current density | 0.8 | 0.8 | 0.8 | 0.8 |
| | (ASD) | | | | |
| | Immersion/ | 0.5 | 0.5 | 0.5 | 0.5 |
| | plating time | | | | |
| | (seconds) | | | | |
| Test results | chromium | 20 | 20 | 20 | 20 |
| | content | | | | |
| | (μg/m²) | | | | |
| | analyzed by | | | | |
| | XRF | | | | |
| | nitrogen | 0.5 | 0.5 | 0.5 | 0.5 |
| | content (wt %) | | | | |
| | analyzed by | | | | |
| | XPS | | | | |
| | C—N signal | Y | Y | Y | Y |
| | detected by | | | | |
| | headspace | | | | |
| | GC/MS (Y/N) | | | | |
| | surface color | <8 | <8 | >10 | >10 |
| | difference ΔE | | | | |
| | of antioxidant | | | | |
| | layer (at 250° C. | | | | |
| | for 10 minutes) | | | | |

| | | Comparative | Comparative |
|---|---|---|---|
| | Items | Example 1 | Example 2 |
| antioxidant | Content of chromic acid | 0.6 | 0.6 |
| solution | (g/L) | | |
| | Content of 5-amino- | 0 | 0 |
| | tetrazole (g/L) | | |
| | Content of benzotriazole | 0 | 0 |
| | (g/L) | | |
| | Content of 1,5- | 0 | 0 |
| | diaminotetrazole (g/L) | | |
| | Content of 2-amino-1,3,4- | 0 | 2 |
| | thiadiazole (g/L) | | |
| | Content of 3,5-diamino- | 2 | 0 |
| | 1,2,4-triazole (g/L) | | |
| Processing | Immersion temperature | 25° C. | 25° C. |
| conditions | (° C.) | | |
| | current density (ASD) | 0.8 | 0.8 |
| | Immersion/plating time | 0.5 | 0.5 |
| | (seconds) | | |
| Test results | chromium content | 20 | 20 |
| | (μg/m²) | | |
| | analyzed by XRF | | |
| | nitrogen content (wt %) | 0 | 0 |
| | analyzed by XPS | | |
| | C—N signal detected by | N | N |
| | headspace GC/MS (Y/N) | | |
| | surface color difference | >20 | >20 |
| | ΔE of antioxidant layer | | |
| | (baked at 250° C. for 10 | | |
| | minutes) | | |

The test results from Table 1 indicate that the antioxidant copper foil prepared in each of Exemplary Examples 1 and 2 has a surface color differences ΔE of not greater than 8 when being baked at 250° C. for 10 minutes. This demonstrates that the antioxidant layer formed by an antioxidant solution containing both 5-amino-tetrazole and benzotriazole (i.e., a combination of nitrogen-containing heterocyclic compounds) can provide the copper foil with superior antioxidant properties and thermal resistance.

### Beneficial Effects of the Embodiments

In conclusion, in the surface treatment method of the copper foil, the antioxidant copper foil, and the cathode of the lithium battery provided by the present disclosure, by virtue of “an antioxidant copper foil including a copper foil substrate and an antioxidant layer formed on a surface of the copper foil substrate,” “the antioxidant layer containing chromium elements derived from a chromic acid compound, and containing nitrogen elements at least partially derived from an aminotetrazole compound and a nitrogen-containing heterocyclic compound,” and “the antioxidant copper foil satisfying the following characteristics: (a) the antioxidant layer has a chromium content of between 5 μg/m² and 35 μg/m² determined by X-ray fluorescence spectroscopy (XRF); (b) the antioxidant layer has a nitrogen content of between 0.1 wt % and 10 wt % determined by X-ray photoelectron spectroscopy (XPS); (c) the antioxidant copper foil has a C—N signal detected by headspace gas chromatography-mass spectrometry; and (d) after baking the antioxidant copper foil at 250° C. for 10 minutes, a surface color difference ΔE of the antioxidant layer is not greater than 8 before and after the baking,” the copper foil of the present disclosure demonstrates a more prominent degree of heat resistance as compared to the conventional copper foil (which uses chromic acid and glucose as components of an antioxidant layer).

Furthermore, the copper foil of the present disclosure is more suitable for use as a cathode material of the lithium battery, thereby enabling a product to have a wider range of applications.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A surface treatment method of a copper foil, comprising:
providing a copper foil substrate;
immersing the copper foil substrate in an antioxidant solution containing a chromic acid compound, an aminotetrazole compound, and a nitrogen-containing heterocyclic compound; and
subjecting the copper foil substrate to be soaked or electroplated in the antioxidant solution for a predetermined time, such that an antioxidant layer is formed on a surface of the copper foil substrate, and an antioxidant copper foil is further formed;
wherein the antioxidant copper foil satisfies the following characteristics:
(a) the antioxidant layer has a chromium content of between 5 μg/m² and 35 μg/m² determined by X-ray fluorescence spectroscopy (XRF); wherein chromium elements in the antioxidant layer are derived from the chromic acid compound;
(b) the antioxidant layer has a nitrogen content of between 0.1 wt % and 10 wt % determined by X-ray photoelectron spectroscopy (XPS); wherein nitrogen elements in the antioxidant layer are at least partially derived from the aminotetrazole compound and the nitrogen-containing heterocyclic compound;
(c) the antioxidant copper foil has a carbon nitrogen signal (C—N signal) detected by headspace gas chromatography-mass spectrometry (headspace GC-MS); and
(d) after baking the antioxidant copper foil at 250° C. for 10 minutes, a surface color difference ΔE of the antioxidant layer is not greater than 8 before and after the baking.

2. The surface treatment method according to claim 1, wherein, in the antioxidant solution, a concentration of the chromic acid compound is between 0.1 g/L and 5 g/L, and the chromic acid compound is selected from the group consisting of chromic acid, dichromic acid, and potassium dichromate.

3. The surface treatment method according to claim 1, wherein, in the antioxidant solution, a concentration of the aminotetrazole compound is between 0.1 g/L and 10 g/L, a concentration of the nitrogen-containing heterocyclic compound is between 0.1 g/L and 10 g/L, and a weight ratio between the aminotetrazole compound and the nitrogen-containing heterocyclic compound is between 1:5 and 5:1.

4. The surface treatment method according to claim 3, wherein the aminotetrazole compound is 5-aminotetrazole, and the nitrogen-containing heterocyclic compound is a bicyclic nitrogen-containing heterocyclic compound.

5. The surface treatment method according to claim 4, wherein the nitrogen-containing heterocyclic compound is benzotriazole.

6. The surface treatment method according to claim 1, wherein the antioxidant solution further contains at least two of 1,5-diaminotetrazole, 2-amino-1,3,4-thiadiazole, and 3,5-diamino-1,2,4-triazole.

7. The surface treatment method according to claim 1, wherein the predetermined time for soaking or electroplating the copper foil substrate in the antioxidant solution is between 0.1 seconds and 10 seconds, and an electroplating condition for electroplating the copper foil substrate is a current density of between 0.1 ASD and 5 ASD (A/dm²).

8. An antioxidant copper foil, comprising:
a copper foil substrate; and
an antioxidant layer formed on a surface of the copper foil substrate;
wherein the antioxidant layer contains chromium elements derived from a chromic acid compound, and contains nitrogen elements at least partially derived from an aminotetrazole compound and a nitrogen-containing heterocyclic compound;
wherein the antioxidant copper foil satisfies the following characteristics:
(a) the antioxidant layer has a chromium content of between 5 μg/m² and 35 μg/m² determined by X-ray fluorescence spectroscopy (XRF);
(b) the antioxidant layer has a nitrogen content of between 0.1 wt % and 10 wt % determined by X-ray photoelectron spectroscopy (XPS);
(c) the antioxidant copper foil has a C—N signal detected by headspace gas chromatography-mass spectrometry; and
(d) after baking the antioxidant copper foil at 250° C. for 10 minutes, a surface color difference ΔE of the antioxidant layer is not greater than 8 before and after the baking.

9. The antioxidant copper foil according to claim 8, wherein a thickness of the copper foil substrate is between 1 micrometer and 10 micrometers, and a thickness of the antioxidant layer is between 1 nanometer and 100 nanometers.

10. A cathode of a lithium battery, comprising the antioxidant copper foil as claimed in claim 8.
